(19) United States
(12) Patent Application Publication
(10) Pub. No.: US 2026/0273787 A1
(43) Pub. Date: Sep. 17, 2026

(54) Food Cutting Guide

(71) Applicant: Nuova Vita Corporation, Hudson, OH (US)

(72) Inventor: Gregory T. Getzinger, Hudson, OH (US)

(73) Assignee: Nuova Vita Corporation, Hudson, OH (US)

(21) Appl. No.: 19/672,871

(22) Filed: May 11, 2026

Related U.S. Application Data
(62) Division of application No. 18/598,330, filed on Mar. 7, 2024.
(60) Provisional application No. 63/479,253, filed on Mar. 27, 2023.

(51) Int. Cl. B26D 3/18

(52) U.S. Cl. CPC B26D 3/185; B26D 2210/02

(57) ABSTRACT

A food cutting guide comprising a body having top and bottom surfaces, a peripheral edge, a thickness, a plurality of cutting slots set in the body and extending therethrough from the top surface to the bottom surface; wherein the body is configured to rest upon and cover a container.

### CROSS-REFERENCE TO RELATED APPLICATIONS

This application claims the benefit of U.S. Provisional Patent Application No. 63/479,253, filed Mar. 27, 2023, which is hereby incorporated herein by reference in its entirety.

### BACKGROUND OF THE INVENTION

Restaurants that serve menu items that are baked in a pan, like lasagna, serve individual portions from the baked pan of lasagna. Portioning pans of lasagna is done freehand, eyeballing portioning the pan when cutting the lasagna. Cutting pans of lasagna by sight invites inconsistent portions of lasagna. Some portions will be bigger than others. When a restaurant servs inconsistent portions, customers get upset. Some customers will complain and/or never come back. Restaurants are forced to discard the smaller portions and serve only the bigger portions. By discarding the smaller portions, the restaurant owner is losing sales and ultimately losing profits.

In addition, the FDA has instituted menu labeling regulations that require food chains of 20 or more to display the calories and nutritional information on the restaurant's main menu. When portions of lasagna are inconsistently portioned, the calories and nutrients are also inconsistent with the advertised menu calories and nutritional information.

The present disclosure overcomes shortcomings and limitations of prior attempts to cut equal portions of food. For example, a food bar cutter by Atwater (US2004/0250667, incorporated herein by reference) teaches a foldable cutter for sectioning food in a baking pan. The device is a grid of perpendicular cutting blades that is pressed into a pan of food to cut the equal sections in a single action. One shortcoming with this device is that when used, the food sections in the central cutting sectors would be tightly held on four sides, so the blades would tend to lift the food out of the pan, and/or partially dislodge the top layers of the food (e.g. lasagna), leading to damaged food items that would be unsightly and undesirable and could not be sold. Another shortcoming is that the device is forced into the food using the user's muscles to press the cutting blades into the food simultaneously. This spreads the force among all the blades and can lead to partial cuts that do not fully section food from top to bottom or are not crisp, clean cuts. The inclusion of numerous blades cutting at once, can spread the force across the top of the food so the cutting pressure is reduced, leading to unsightly smashed or deformed top surface of the food. Moreover, the cutting grid would need to be washed between uses, and due to the numerous intersecting blades, it would be a time consuming process to fully clean each corner where the cutters intersect.

The present disclosure assures each pan of food is cut into equal portions. The cutting is easy to perform, and the cuts are crisp and clean. Every portion in the pan is more likely to be sold. There is no waste, and the customer is receiving the advertised calories and nutrients. The owner receives a profit from every portion in every pan.

### BRIEF SUMMARY OF THE INVENTION

The present disclosure is directed to a food cutting guide comprising a body having top and bottom surfaces, a peripheral edge, a thickness, a plurality of cutting slots set in the body and extending therethrough from the top surface to the bottom surface; wherein the body is configured to rest upon and cover a container.

The food cutting guide may be configured such that the body is a rigid body.

The food cutting guide may be configured such that the body is rectangular.

The food cutting guide may be configured such that the body is square.

The food cutting guide may be configured such that the plurality of slots is parallel and arranged in a first common direction.

The food cutting guide can further include a second body having a plurality of parallel slots arranged in a second common direction, wherein the second common direction is orthogonal to the first common direction.

The food cutting guide may be configured such that the body has a major axis and a minor axis perpendicular to the major axis, wherein the major axis extends in a length direction and the minor axis extends in a width direction.

The food cutting guide may be configured such that the first common direction is parallel to the major axis and the second common direction is parallel to the minor axis.

The food cutting guide may be configured such that the first common direction is horizontal, and the second common direction is vertical.

The food cutting guide can include a transverse slot disposed perpendicular to and intersecting the plurality of cutting slots.

The food cutting guide can include a contiguous rectangular groove in the bottom surface of the body configured to accept an upper perimeter edge surface of a container.

The food cutting guide can include a container having a perimeter wall, the perimeter wall having a shelf set into the perimeter wall sized to accept and constrain the peripheral edge of the body.

The food cutting guide may be configured such that the perimeter wall is configured to constrain the body on at least three sides and configured to permit a sliding movement of the body along the shelf.

The food cutting guide can include a food container comprising a rectangular tray having a bottom base and perimeter, a plurality of walls disposed about the perimeter, each wall extending upward a first distance from the base to a horizontal support surface to define a lower wall portion and further extending upward a second distance from the horizontal support surface to a wall top edge to define an upper wall portion, wherein the horizontal support surface is configured to accept the food cutting guide, and the upper wall portion is configured to constrain the body along the peripheral edge.

The food cutting guide may be configured such that each of the cutting slots have a pair of terminal ends and the cutting body further comprises a plurality of connective support structures disposed between the terminal ends of the cutting slots and the peripheral edge.

The disclosure also is directed to a method of cutting food in a tray comprising providing a food in a tray, the tray having a bottom surface and peripheral walls, the food covering the bottom surface and extending to the peripheral walls, providing a cutting body having a plurality of slots, each slot having proximal and distal ends, positioning the cutting body above the food in the tray, inserting a cutting tool into one of the plurality of slots at the proximal end such that the cutting tool extends though the slot and though the food in the tray to contact the bottom surface of the tray, moving the cutting tool to the distal end, forming a through-cut in the food, removing the cutting tool.

The method can include using a cutting tool selected from a spatula, a knife, and a fork.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a top plan view of a first exemplary food cutting body;

FIG. 2 is a top plan view of a second exemplary food cutting body;

FIG. 3 is a top plan view of an alternate embodiment of an exemplary food cutting body;

FIG. 4 is a top plan view of an exemplary food container;

FIG. 5 is a front view of the food container of FIG. 4;

FIG. 6 is a front cross-sectional view of the food container of FIG. 4;

FIG. 7 is a side view of the food container of FIG. 4;

FIG. 8 is a side cross-sectional view of the food container of FIG. 4;

FIG. 9 is a side cross-sectional view of the food container of FIG. 4 that includes an exemplary cutting body;

FIG. 10 is a bottom plan view of an alternate embodiment of an exemplary food cutting body;

FIG. 11 is a top view of the food cutting body of FIG. 10;

FIG. 12 is a side cross-sectional view of the food cutting body of FIG. 10;

FIGS. 13A and 13B are top plan views of an alternate embodiment of an exemplary food cutting system; and

FIGS. 14A-14D are top plan views of an alternate embodiment of an exemplary food cutting system.

### DETAILED DESCRIPTION

The present disclosure is directed to a cutting guide for cutting equal sized portions of food that are prepared in a tray or dish, such as lasagna, casseroles, cakes, or brownies. Equally portioning pans of lasagna is beneficial for the restaurant owner. Typically, a restaurant owner will cut a pan of lasagna into larger portions in the pan to mask inconsistent unequal portioning. Using a cutting guide allows the restaurant owner to make smaller, but consistent portions, which increases the number of portions per pan, which allows higher sales and profits per pan.

The food cutting guide combines a pan and one or more cutting boards (also referred to as cutting bodies or cutting guide bodies). The pan is formed with an upper interior shelf below the top of the pan to hold a single cutting board, or a set of two cutting boards, that have portion-cutting slots. The cutting boards are sized to fit inside the pan and above the lasagna or other food. The pan is formed with a shelf that supports two rectangular cutting boards with slots.

In an exemplary embodiment, one of the rectangular boards is for cutting the pan of lasagna horizontally. The second cutting board has slots to cut the pan of lasagna vertically. When both cutting boards are used, the pan of lasagna is consistently and perfectly cut into equal portions. When the cutting boards are not in use and resting on top and inside the pan, the cutting boards sit flush with the pan, the cutting boards acting as a cover for the pan. The pan can be made to have different lengths, widths, and depths (for example a lasagna pan will be deeper than a brownie pan).

The food cutting guide generally has two parts: one or two cutting guide bodies and the food container (tray or pan) that holds the cutting bodies. Both parts are sized to fit together with minimal room for movement of the cutting bodies. The cutting bodies are square or rectangular in shape. The cutting bodies include one or more parallel slots wide enough to fit a cutting knife, spatula or any other device used for cutting food made in baking pans. There can be one or two cutting bodies for the baking pan.

The food cutting guide uses one or more cutting guide bodies, each body having a major axis and a minor axis perpendicular to the major axis, wherein the major axis extends in a length direction and the minor axis extends in a width direction. Each of the food cutting bodies has a plurality of parallel slots arranged in first and second common directions, wherein the second common direction is orthogonal to the first common direction. The food cutting guide can be configured such that the first common direction is parallel to the major axis and the second common direction is parallel to the minor axis.

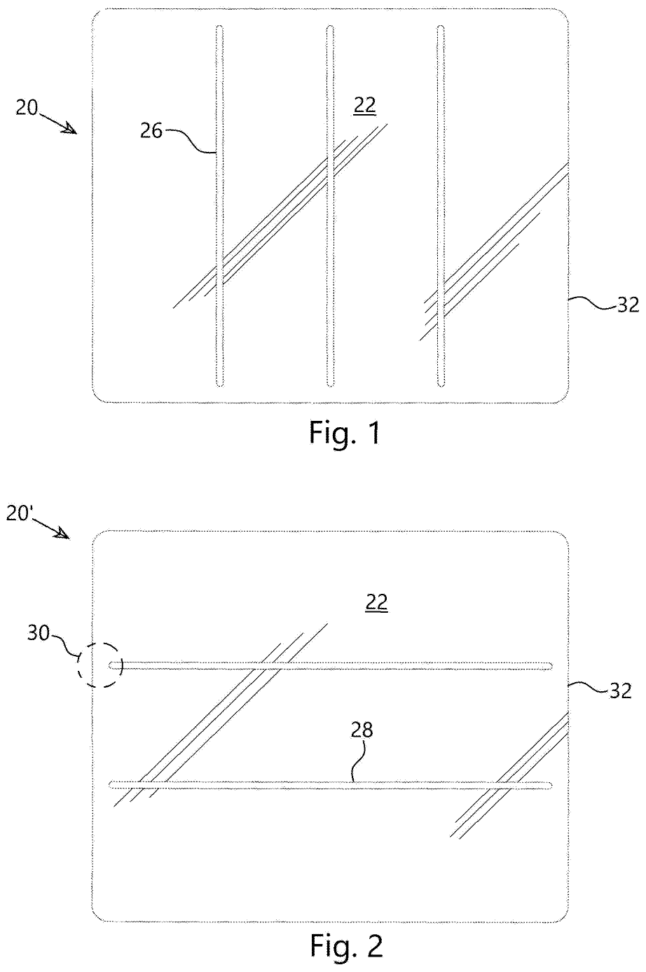

Exemplary cutting bodies are shown in FIGS. 1 and 2. The cutting guide body 20 (also referred to as the cutting body) has a top surface 22 and bottom surface 24. The cutting body 20 has several parallel though-slots 26 that extend though the cutting body from the top surface 22 through to the bottom surface 24. The cutting body 20 can be made from many different materials, such as wood, plastic, bamboo, composite material, stainless steel, metal, aluminum, glass, ceramic, or any other high heat baking and food safe material. The number of slots 26 can be customized for each customer's desired size portion. The cutting body is sized to fit snugly into the top of a tray or pan 40, where the pan is configured to have a support shelf 56 formed into the structure of the side wall 52 of the pan 40. An exemplary body 20 is 1/16^{th} inch smaller in length and width than the length and width of an exemplary pan 40, such that the body 20 fits between vertical upper walls 54 of the ledge 56. The cutting body 20 rests on the pan's ledge 56.

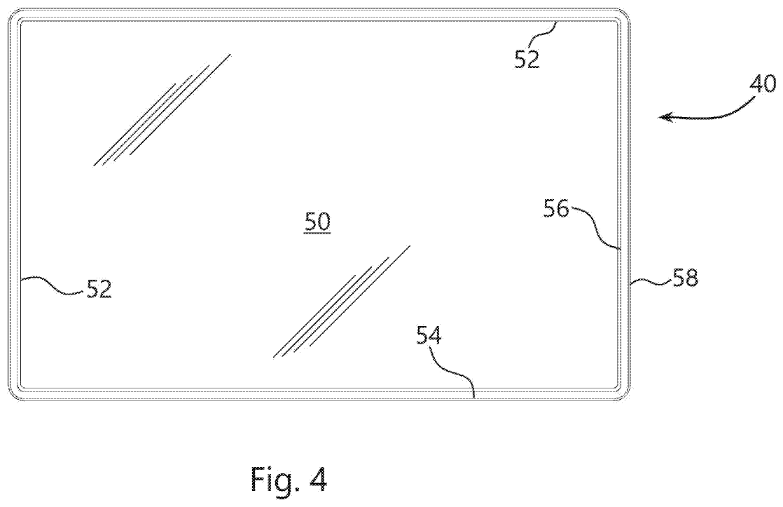

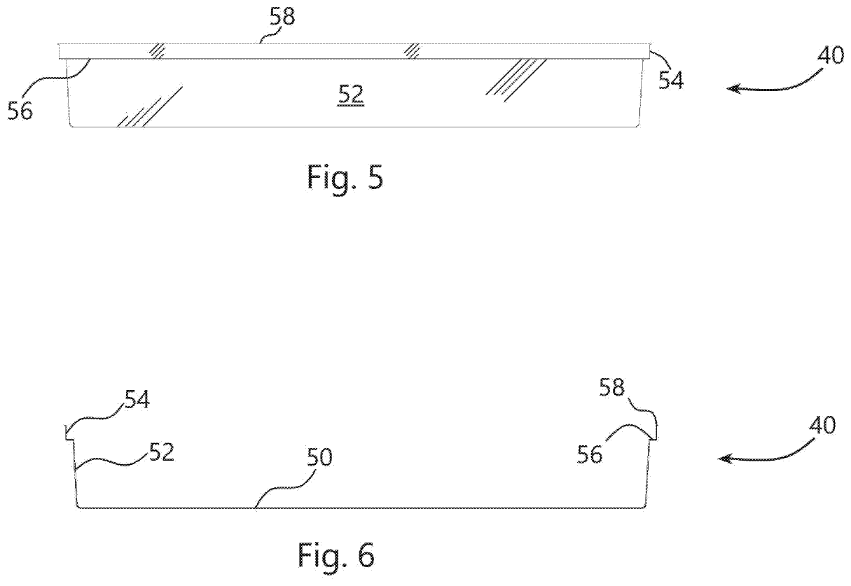

In an exemplary embodiment, two cutting bodies 20, 20′ are used. A first cutting body 20 has cutting guide slots 26 oriented in a vertical direction, and a second cutting body has slots 28 oriented in a horizontal direction. The first cutting body 20 is inserted into the top support shelf/ledge 56 inside the pan 40 (See FIGS. 4-9). The upper wall 54 of the pan 40 constrains the cutting body 20, preventing movement and keeping the cutting body 20 in a fixed position relative to the food to be cut. The user cutting the lasagna inserts a cutting tool (such as a spatula, knife, flat fork, or other cutting utensil) into the slot 26, which constrains and guides the cutting tool to follow the slot, guiding the cutting tool to cut the lasagna in one direction (vertical or horizontal). Once the cutting tool reaches the end of the slot 26, having traveled the full length of the slot 26, the tool is removed and inserted into the next parallel slot 26 and the process is repeated. Once all the slots 26 in a cutting body 20 have been used, the lasagna is considered fully cut in one direction. The cutting body 20 is then removed from the pan 40, and the second cutting body 20′ is inserted into the pan 40, resting on the same ledge 56. The user then uses the slots 28 in the cutting body 20', following the same procedure as used with the first cutting body 20, to guide the cutting tool to cut the lasagna in the other direction (horizontal or vertical), making cuts perpendicular to the cuts made using the first cutting body 20.

In an alternate exemplary embodiment, a single square cutting body 20 is used in place of the two cutting bodies 20, 20', and a square pan 40 is used in place of a rectangular pan 40. As with the previously described cutting body, the square cutting body has a series of parallel cutting guide slots 26. The square cutting body 20 is inserted into the top support shelf/ledge 56 inside the pan 40. The upper wall 54 of the pan 40 constrains the cutting body 20, preventing movement and keeping the cutting body 20 in a fixed position relative to the food to be cut. The user cutting the lasagna inserts a cutting tool into the slot 26, which constrains and guides the cutting tool to follow the slot, guiding the cutting tool to cut the lasagna in one direction (vertical or horizontal). Once the cutting tool reaches the end of the slot 26, having traveled the full length of the slot 26, the tool is removed and inserted into the next parallel slot 26 and the process is repeated. Once all the slots 26 in a cutting body 20 have been used, the lasagna is considered fully cut in one direction. The cutting body 20 is then removed from the pan 40, rotated 90°, and reinserted into the pan 40, resting on the same ledge 56. The user then uses the slots 26 in the square cutting body 20, following the same procedure as described above, to guide the cutting tool to cut the lasagna in the other direction (horizontal or vertical), making cuts perpendicular to the cuts made using the square cutting body in its previous orientation.

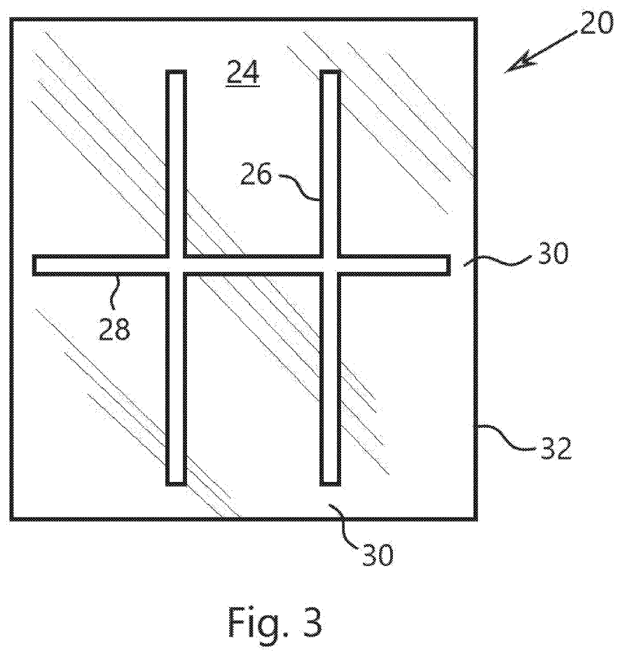

The number of slots can vary between the cutting bodies. For example, a pair of cutting bodies can be made with two vertical and two horizontal slots, which when used in combination can cut nine equal portions. As another example, one cutting body can have two horizontal slots and the other cutting body can have three vertical slots, which when used in combination can cut 12 equal portions, etc. In a further example (shown in FIG. 3), a single cutting body can have two vertical slots 26 and a single perpendicular/orthogonal horizontal slot 28 that intersects the vertical slots, which can be used to cut six equal portions. In the exemplary embodiment shown in FIG. 3, two parallel slots 26 are shown for ease of illustration, but the cutting body 20 could have three or four parallel slots 26.

The food cutting bodies can include an arbitrary number of slots to combine to produce several different portions. In the case of a single cutting body, the only limit is if the cutting body has two or more parallel slots, the cutting body can have at most a single perpendicular intersecting cutting slot, since more than one perpendicular slot would result in an unconnected, unsupported loose center section(s) of the cutting body (for example, a tic-tac-toe shaped arrangement would result in the center square falling out). As used herein, the terms “horizontal slot(s)” and “vertical slot(s)” are used for ease of illustration and intended to denote any arrangement of slots that are perpendicular/orthogonal to one another. For example, the exemplary embedment shown in FIG. 3, upon rotating the body 90°, could alternatively be described as having two horizontal slots 26, and a single vertical slot 28.

The cutting bodies have a connective support structure 30 between the terminal ends of each of the slots 26, 28 and the peripheral edge 32 of the cutting body 20. This connective support structure is necessary to retain the integrity of the cutting body and to retain the precise sizing of the cutting slots 26, 28.

An exemplary embodiment of a food container 40 (also referred to as a tray or pan) is shown in FIGS. 4-9. The pan 40 is a food container comprising a square or rectangular tray having a bottom base 50 and perimeter, several walls 52 disposed about the perimeter of the base, each wall extending upward a first distance from the base 50 to a horizontal support surface 56 to define a lower wall portion 52. The wall further extends upward a second distance from the horizontal support surface to a wall top edge 58 to define an upper wall portion 54. The horizontal support surface is configured to accept the food cutting body 20, and the upper wall portion 54 is configured to constrain the body 20 along its peripheral edge 32. The bottom base 50 is also referred to as the bottom surface 50, which is the surface that contacts the bottom/underside of the food.

The front view (FIG. 6) and side view (FIG. 8) of the pan 40 shows that the base 50 of the pan is smaller than the top wall 58 of the pan where the cutting body 20 rests on the ledge 56. From the ledge 56, an upper vertical wall 54 extends to retain the cutting body 20. An exemplary pan has an upper wall 54 measuring .50 inches high. The enclosed side walls 54 allow for the two cutting bodies 20 to rest inside the pan 40, one on top of another, above the baking area 50, on the ledge 56.

An exemplary shelf 56 of an exemplary pan 40 is .25 inches wider on all four sides than the base 50 of the pan 40 where the lasagna is baked. The ledge 56 is the resting point for the cutting body(ies) 20. When both cutting bodies 20 are resting on top of the ledge 56, the bodies 20 act as a cover for the pan 40 and a convenient set for storage.

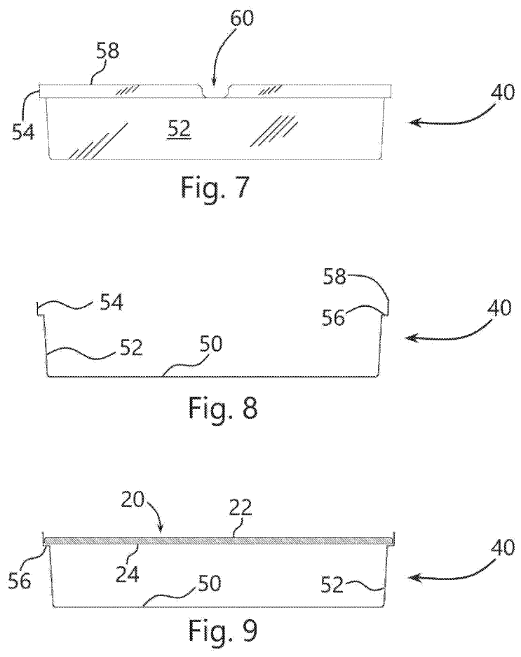

As shown in FIG. 7, gaps 60 in the top wall 54 of the pan 40 are located on opposite sides of the pan to allow the user to grip the side surfaces 32 of the cutting body 20 and remove the cutting body 20 from the pan 40. The gaps 60 can be in two (opposing) walls or all four walls.

An exemplary cutting body is sized to have a 1/16 inch space between the edge 32 of the cutting body and the interior of the upper wall 54 of the pan 40. This allows the cutting body to fit snugly inside the pan 40 and on top of the ledge 56. Thus, the cutting body 20 is constrained from moving, but can still be removed from the pan 40 by a user.

An exemplary pan has a base used for baking that is ½ inch in length and width shorter than the top ½ inch of the pan. The top half of the baking pan has a ¼ inch ledge with walls that continue upwards by a ½ inch. The horizontal walls above the ledge have a half moon cutout gap for setting and lifting the cutting body from the pan.

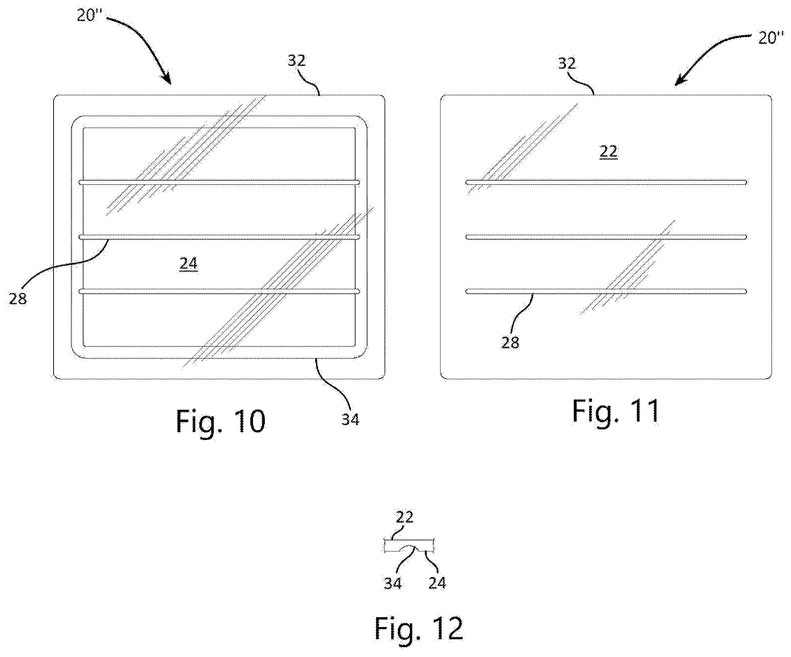

An alternate exemplary embodiment of a cutting body 20″ is shown in FIGS. 10-12. The cutting body 20″ is similar to the cutting bodies 20 noted above, but is configured to rest on top of the upper wall 58 of a tray or food container 40. The upper wall 58 is received into a groove 34 set into the bottom surface 24 of the cutting body 20″. The groove 34 accepts the top wall 58 of the tray 40 to constrain the cutting body 20″ from moving relative to the food in the tray 40 in order to facilitate cutting equal portions of food using the methods noted above.

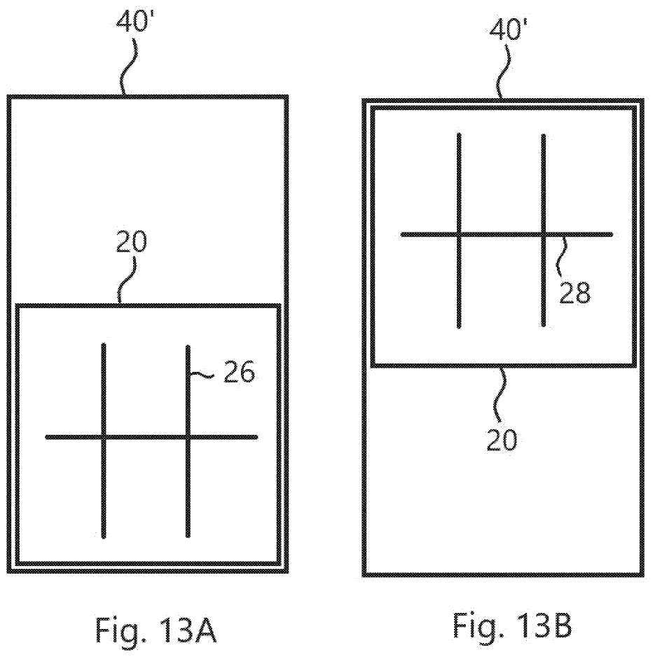

An alternate exemplary embodiment of a food cutting guide and system using container 40′ is shown in FIGS. 13A-13B. The exemplary food tray 40′ is longer or wider than the tray 40 shown in FIGS. 4-9 in one dimension, such that the tray 40′ constrains the cutting body on three sides as opposed to all four sides, as described above. This allows the cutting body 20 to slide from side to side, but not in any other direction, and prevents rotation of the cutting body 20. A user performs the cutting procedure as noted above, inserting the cutting tool into slots 26, 28. After cutting using all the slots, the cutting body 20 is slid to the other end of the tray 40′ and the process is repeated, which produces even more equal sized portions. The dimensions shown in the drawing are not to scale but are shown for ease of illustration; the dimensions of the cutting body 20 and tray 40′ must be sized to account for repositioning the cutting body 20 in order to produce equal sized portions. As illustrated in FIGS. 13A-13B, nine portions could be produced: Starting with the configuration shown in FIG. 13A, three cuts would produce six cut portions, where the portions in the upper/top (relative to the page of drawings) end tray would be larger than the lower portions. Next, moving to the configuration of FIG. 13B, three more cuts would further divide the upper portions to fully section the food and arrive at nine equal portions.

The dimensions shown in the drawing are not to scale but are shown for ease of illustration; the dimensions of the cutting body 20 and tray 40′ must be sized to account for repositioning the cutting body 20 in order to produce equal sized portions. As illustrated in FIGS. 13A-13B, nine portions could be produced: Starting with the configuration shown in FIG. 13A, three cuts would produce six cut portions, where the upper portions are larger than the lower portions. Next, moving to the configuration of FIG. 13B, three more cuts would further divide the upper portions to fully section the food and arrive at nine equal portions. However, the cutting guide is not limited as shown and could have three or more parallel slots 26, which when operated as described above would produce 12 or more portions.

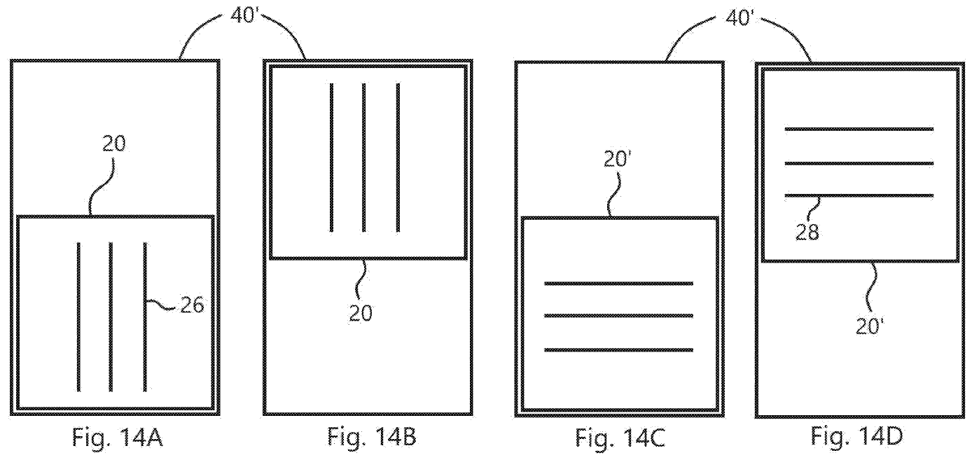

An alternate exemplary embodiment of a food cutting guide and system using container 40′ is shown in FIGS. 14A-14D. The exemplary food tray 40′ shown in FIGS. 14A-14D is longer or wider than the tray 40 shown in FIGS. 4-9 in one dimension, such that the tray 40′ constrains the cutting body on three sides as opposed to all four sides, as described above. This allows the cutting body 20 to slide from side to side, but not in any other direction, and prevents rotation of the cutting body 20. A user performs the cutting procedure as noted above, inserting the cutting tool into each of the slots 26 to make cuts. After cutting using all the slots 26, the cutting body 20 is slid to the other end of the tray 40′ and the process is repeated, which produces long parallel portions. Next, the user removes the first cutting body 20 and replaces it with the second cutting body 20'. The user then inserts the cutting tool and cuts using each cutting slot 28, then slides the cutting body 20′ to the other end and make another series of cuts. This produces a series of perpendicular or orthogonal intersecting cuts and sections the food into equal portions.

The dimensions shown in the drawing are not to scale but are shown for ease of illustration; the dimensions of the cutting body 20′ and tray 40′ must be sized to account for repositioning the cutting body 20′ in order to produce equal sized portions. However, the cutting guide is not limited as shown and the first and second cutting bodies 20, 20′ could have two, or four or more parallel slots 26,28 and combinations thereof, which when operated as described above would produce numerous equal portions.

Many parts of this exemplary embodiment, like many other inventions, can have all the parts manipulated into different lengths, widths, and heights not proportional to all of the figures provided. While not being proportional all elements can still be configured to be the perform the same basic principal function. This must be particularly pointed out for this type of invention due to the nature of the invention, needing to accommodate different firing platforms and barrels.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something and is not intended to indicate a preference.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

1-17. (canceled)

18. A food cutting apparatus comprising:
a first body having
top and bottom surfaces,
a peripheral edge, and
a thickness,
a plurality of cutting slots set in the first body and extending therethrough from the top surface to the bottom surface;
a container having a perimeter wall, the perimeter wall having a shelf set into the perimeter wall sized to accept and constrain the peripheral edge of the first body;
wherein the first body is configured to rest upon the shelf in the container.

19. The food cutting apparatus of claim 18, wherein the plurality of slots is parallel and arranged in a first common direction.

20. The food cutting apparatus of claim 19, further comprising a second body having a plurality of parallel slots arranged in a second common direction, wherein the second common direction is orthogonal to the first common direction.

21. The food cutting apparatus of claim 20,
wherein each of the first and second bodies has a major axis and a minor axis perpendicular to the major axis,
wherein the major axis extends in a length direction and the minor axis extends in a width direction, and
wherein the first common direction is parallel to the major axis and the second common direction is parallel to the minor axis.

22. The food cutting apparatus of claim 18, further comprising a transverse slot disposed perpendicular to and intersecting the plurality of cutting slots.

23. The food cutting apparatus of claim 20, wherein the first and second bodies are rigid bodies.

24. The food cutting apparatus of claim 20, wherein the first and second bodies are selected from rectangular and square.

25. The food cutting apparatus of claim 18, wherein the container has a bottom base and perimeter, a plurality of walls disposed about the perimeter, each wall extending upward a first distance from the base to a horizontal support surface to define the shelf and further extending upward a second distance from the shelf to a wall top edge to define an upper wall portion, wherein the upper wall portion is configured to constrain the first body along the peripheral edge.

26. The food cutting apparatus of claim 25, wherein the second distance is at least twice the thickness of the first body.

27. The food cutting apparatus of claim 25, wherein the top wall edge has one or more gaps along a perimeter to facilitate removal of the first body.

28. The food cutting apparatus of claim 18, wherein each of the cutting slots have a pair of terminal ends and the cutting body further comprises a plurality of connective support structures disposed between the terminal ends of the cutting slots and the peripheral edge.

29. A method of cutting food in a tray comprising
(i) providing the food in the tray, the tray having a bottom surface, peripheral walls, and a shelf set into the peripheral walls, the food covering the bottom surface and extending to the peripheral walls,
(ii) providing first and second cutting bodies, each having a plurality of slots, each of the plurality of slots having proximal and distal ends,
(iii) positioning the first cutting body above the food in the tray, supported on the shelf,
(iv) inserting a cutting tool into one of the plurality of slots at the proximal end of the one of the plurality of slots such that the cutting tool extends though the one of the plurality of slots and though the food in the tray to contact the bottom surface of the tray,
(v) moving the cutting tool to the distal end of the one of the plurality of slots, forming a through-cut in the food,
(vi) removing the cutting tool,
(vii) removing the first cutting body,
(viii) positioning the second cutting body above the food in the tray, supported on the shelf,
(ix) repeating steps (iv) through (vi).

30. The method of claim 29, wherein the cutting tool is selected from a spatula, a knife, and a fork.

31. A food cutting apparatus comprising:
first and second bodies, each body having
top and bottom surfaces,
a peripheral edge, and
a thickness,
a first plurality of parallel cutting slots set in the first body arranged in a first common direction and extending therethrough from the top surface to the bottom surface;
a second plurality of parallel cutting slots set in the second body arranged in a second common direction and extending therethrough from the top surface to the bottom surface, the second common direction being orthogonal to the first common direction;
a container having a bottom base and perimeter, a plurality of walls disposed about the perimeter, each wall extending upward a first distance from the base to a horizontal support surface and further extending upward a second distance from the horizontal support surface to a wall top edge to define an upper wall portion;
wherein the horizontal support surface is configured to accept at least one of the first and second bodies; and
wherein the upper wall portion constrains at least one of the first and second bodies along the peripheral edge.

32. The food cutting apparatus of claim 31, wherein the second distance is at least the thickness of the first and second bodies.

33. The food cutting apparatus of claim 31, wherein the top wall edge has one or more gaps along a perimeter to facilitate removal of the first or second bodies.
